(19) United States
(12) Patent Application Publication
(10) Pub. No.: US 2002/0133376 A1
(43) Pub. Date: Sep. 19, 2002

(54) Health care network with durable medical equipment prescription and physician signature services

(76) Inventors: James Fritschen, Lookout Mountain, TN (US); Marion R. Rice, Rochelle, TX (US); Bindu R. Rao, Austin, TX (US)

Correspondence Address: Christopher C. Winslade, 2135 N. Clifton Ave. #1, Chicago, IL, 60614, US

(21) Appl. No.: 09/823,891

(22) Filed: Mar. 30, 2001

Related U.S. Application Data
(60) Provisional application No. 60/210,765, filed on Jun. 12, 2000.

(51) Int. Cl. G06F 17/60

(52) U.S. Cl. 705/2

(57) ABSTRACT

A health care network that is used by doctors, patients, nurses, DME offices, hospitals, etc. employs digital signatures and/or electronic image signatures for providing authentication, approval support, as well as security while accessing documents and other information. Electronic image signatures are attached to provide information about the approval, by physicians, of DME related documents and certificates of necessity. Electronic image signatures are used along with digital signatures to authenticate the documents and other information. When a user, such as a doctor, signs a document, such as a patient's documents, an electronic image signature of the user is selectively employed, along with the user's digital signatures that are based on public and private keys, to authenticate the user and determine the identity of the signer. Such a mechanism makes it possible to employ the electronic image signature as proof of the user having signed the document. In addition, when the document is printed or viewed on the screen, the inclusion of the electronic image signature on the display or the insertion of the watermarked electronic image signature in the printed output helps confirm the fact that the document has been previously signed, while also providing information about the signer's identity.

### CROSS-REFERENCE TO RELATED APPLICATIONS

This application makes reference to, and claims priority to and the benefit of, U.S. provisional application Ser. No. 60/210,765 filed Jun. 12, 2000.

### STATEMENT REGARDING FEDERALLY SPONSORED RESEARCH

NA

### INCORPORATION BY REFERENCE

U.S. provisional application Ser. No. 60/210,765 filed Jun. 12, 2000 is hereby incorporated by reference herein in its entirety.

### BACKGROUND OF THE INVENTION

1. Technical Field

The present invention relates generally to the health care industry, and, more specifically, to the prescription of durable medical equipment (DME) to patients by physicians, and services that support the signing of certificate of medical necessity (CMN) for the DME by physicians.

2. Related Art

The health care industry is not computerized for the most part and much of the referral, assessment, form generation, and form processing take place manually. In addition, data entry by various participants in the industry needs to be manually verified and processed. Similarly, patient and patient care information are often manually maintained by nurses and physicians. Manual entry of information is an error prone process where information collected and provided is often partially, and sometimes totally, wrong or unusable. In addition, physicians often have to sign their signatures on paper documents, that are often manually filled or printed using computer software, as part of an approval process.

### SUMMARY OF THE INVENTION

Aspects of the present invention may be found in a healthcare network that supports the prescription of durable medical equipment (DME). The network includes one or more databases that may initially store DME information regarding a patient and a certificate of medical necessity. The network further has a web server that is communicatively coupled to the database(s), and a physician computer that is in turn communicatively coupled to the web server. The computer runs browser software that is used by the physician to review the DME information and the certificate of medical necessity. The web server selectively delivers one or web pages to the physician computer that present the certificate of medical necessity and the DME information for review by the physician. The physician computer responds to input from the physician by at least initiating approval of the certificate of medical necessity, and communicating an approved certificate of medical necessity to the web server. The web server then stores the approved certificate of medical necessity in the database(s) for future access.

In one embodiment, the healthcare network also includes a second web server, which may be associated with a DME provider, for example, that enables the DME provider to subsequently review the DME information and the approved certificate of medical necessity. Also, the second web server may initially communicate the DME information and the certificate of medical necessity to the first web server. The DME information may be generated by a care provider, such as a nurse, for example, and communicated to the second web server for ultimate communication to the first web server.

The healthcare network may also include DME advisor software that assists a care provider, such as a doctor or nurse, for example, in the creation of a DME care plan. The DME advisor software may be associated with any one or more of the physician computer, the first web server or the second web server.

In one embodiment, the system further includes yet another web server associated with a billing system. The first web server may communicate the DME information and the approved certificate of medical necessity to the billing system web server for generation of billing information using the DME information and the approved certificate of medical necessity.

Other aspects, advantages and novel features of the present invention will become apparent from the following detailed description of the invention when considered in conjunction with the accompanying drawings.

### BRIEF DESCRIPTION OF THE DRAWINGS

The numerous objects and advantages of the present invention may be better understood by those skilled in the art by reference to the accompanying figures in which:

FIG. 1 is a perspective diagram of health care network that facilitates creation, review and signing of DME information by a physician using a physician's computing system, such DME information being maintained by a durable medical equipment computing system;

FIG. 2 is a perspective diagram of a health care network where a physician reviewing DME related information on a doctor's computer can review and selectively sign certificates of necessity and DME related documents presented for review by a DME Provider computing system over Internet, Dial-Up and/or Other Public or Private Network, the certificates of necessity and DME related documents stored at and maintained by a web-based DME Management system; and

FIG. 3 is a perspective diagram of a health care network that shows data entry of DME care plans and certificates of necessity plans by a nurse using nurse's fax, the subsequent cleanup and processing of such information by a DME Provider at the DME Provider computing system signoff by a doctor using a doctor's computer and the eventual archival of such information at a web-based DME management system.

### DETAILED DESCRIPTION OF THE INVENTION

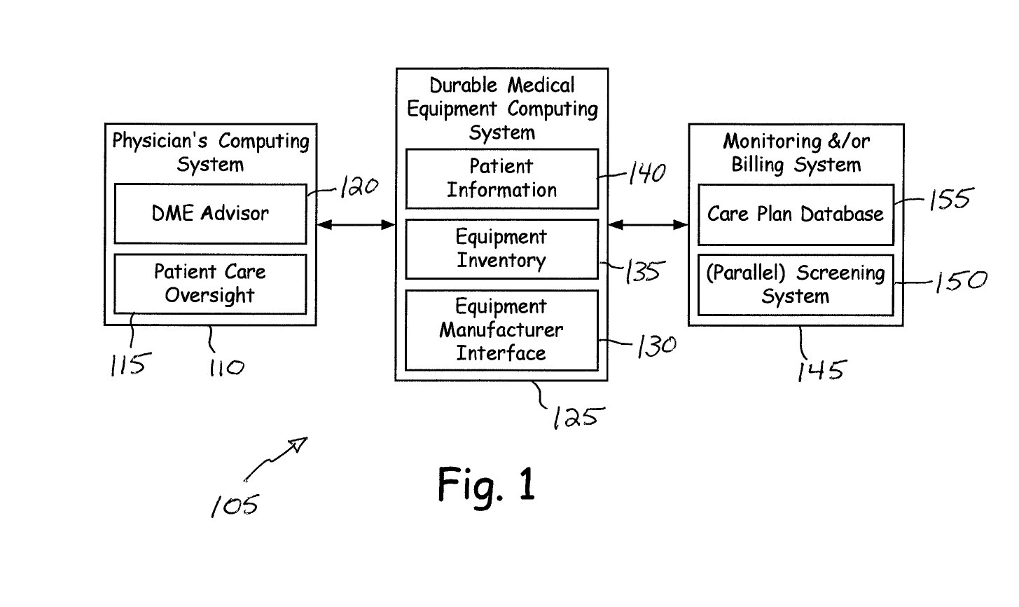

FIG. 1 is a perspective diagram of health care network 105 that facilitates creation, review and signing of DME information by a physician using a physician's computing system 110, such DME information being maintained by a durable medical equipment computing system 125. The home health care network 105 comprises the DME computing system 125, the physician's computing system 110, and a monitor and/or billing system 145.

The DME computing system 125 interacts with the physician's computing system 110 to provide DME related documents, certificates of necessity, etc. to physicians and nurses and to solicit the physician's signature on the certificates of necessity and DME documents, etc., as part of an approval process. The DME certificates of necessity and other related information are selectively forwarded to the monitoring and/or billing system 145 to provide information about services provided and associated billing activities.

Typically, a care provider such as a physician, nurse, medical assistant, etc., creates a certificate of medical necessity for a patient using the physician's computing system 110, or by downloading a form from the DME computing system 125, filling it in and electronically transferring it to the DME computing system 125. In one embodiment, certificate of medical necessity for a patient are faxed or mailed by physicians to the DME office where the certificate of medical necessity is entered into the DME computing system 125 as an image or as a form of data.

The DME computing system 105 processes the certificate of medical necessity communicated to it by the care provider to determine if the DME being provided to a patient is the right one and if the patient is entitled to the DME. In addition, billing information associated with DME provided by the DME office to a patient is analyzed by the DME computing system 125. Such billing information is also selectively communicated to the monitor and/or billing system 145.

The physician's computing system 110 comprises a DME adviser 120, and a patient care oversight software 115. The DME adviser 120 helps the care provider determine the needs of a patient and create a DME care plan for the patient, which is subsequently communicated to the DME computing system 125. The patient care oversight unit 115 facilitates review of patient care information, information on DMEs delivered to patients by DME offices, and certificates of necessities requiring approval of the physician. The patient care oversight software 115 provides screens where certificates of necessity, DME related documents, various communications from DME offices, etc, are presented to the physician, and the physician, using the patient care oversight software 115, can selectively sign the certificates of necessity and DME related documents, using digital signatures and/or electronic image signatures.

The signed certificates of necessity and DME related documents are typically maintained by the DME computing system 125 and presented to the physician over the health care network 105 for review and approval via signing.

DME care plans may be manually created. Therefore, they need to be checked for errors and for verification of eligibility for DME provided. The process of manual creation of a DME care plan is likely to be more error prone and in need of data cleanup at the health care computing system 105. In one embodiment, the DME care plans created either manually or using the physician's computing system 110 are communicated selectively in an electronic format to the monitoring and/or billing system 145 via the DME computing system 125.

The DME Computing system 125 comprises a patient information database 140 used to save patient and patient care information, an equipment inventory 135 used to keep track of their inventory of DME, and an equipment manufacturer interface 130 used for placing orders with one or more DME manufacturers.

The monitoring and/or billing system 145 comprises a care plan database 155 that serves as a reference database for all kinds of care plans to be selectively used as a resource by physicians in determining the right DME and care plan for their patients, and a screening system 150 that automatically reviews certificates of necessity and billing information of selected patients.

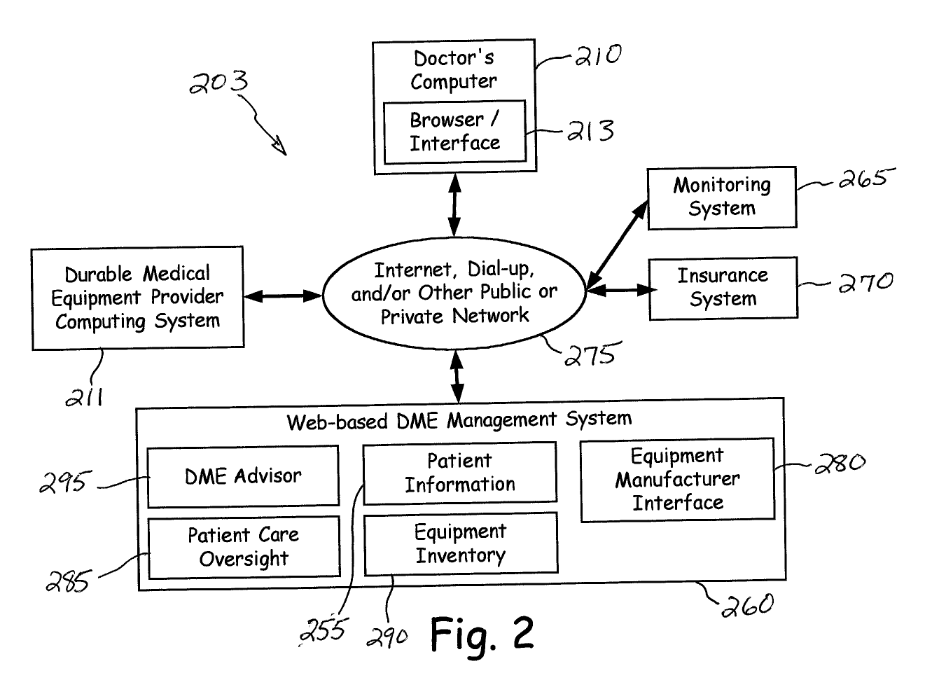

FIG. 2 is a perspective diagram of a health care network 203 where a physician reviewing DME related information on a doctor's computer 210 can review and selectively sign certificates of necessity and DME related documents presented for review by a DME provider computing system 211 over internet, dial-up and/or other public or private network 275, the certificates of necessity and DME related documents being stored at and maintained by a web-based DME management system 260. In addition, a monitoring system 265 and an insurance system 270 provide web-based monitoring services for DME and DME related services provided, and insurance services for DME, respectively.

In one embodiment, the web-based DME management system 260 comprises a centralized repository of patient information 255, equipment information and equipment inventory 290 for various DME offices, an equipment manufacturer interface 280, a DME advisor 295 and a patient oversight database 285.

Physicians reviewing patient information, DME related documents and certificates of necessity that are created by DME provider computing system 210 are presented such information by the Web-based DME management system 260. When physicians sign DME documents and certificates of necessity, etc. the signed documents are stored at Patient care oversight database 285 by the web-based DME management system 260. Such signed documents (and other related information) are selectively reviewed by DME offices via the DME provider computing system and over the internet 275.

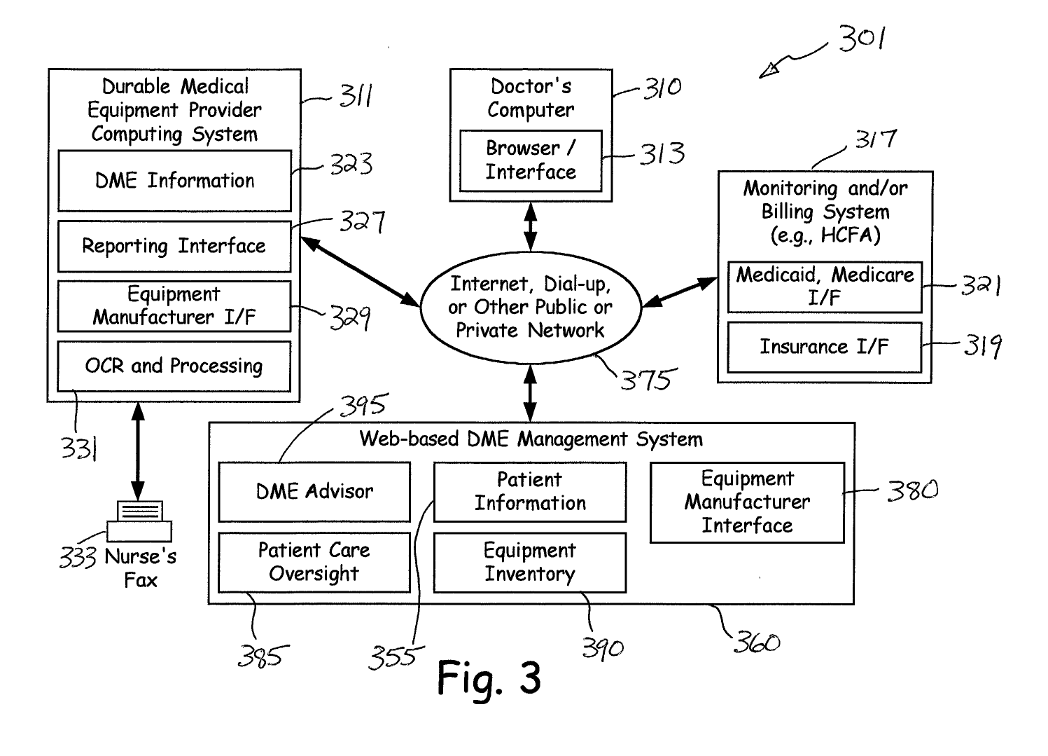

FIG. 3 is a perspective diagram of a health care network 301 that shows data entry of DME care plans and certificates of necessity plans by a nurse using nurse's fax 333, the subsequent cleanup and processing of such information by a DME provider at the DME provider computing system 310, signoff by a doctor using a doctor's computer 310 and the eventual archival of such information at a web-based DME management system 360. DME related documents, DME care plans, certificates of necessity, etc., faxed by a nurse over nurse's fax 333 are selectively OCRed (subjected to optical computer recognition) by an OCR and processing unit 331 at the DME Provider computing system, and all such documents are stored at the web-based DME management system 380 for subsequent access and signing by a physician using the doctor's computer 310.

Doctor's and DME offices communicate with each other using the messaging facilities provided by the web-based DME management system 360. In addition, a monitoring and/or billing system (such as HCFA) provides a Medicaid, Medicare interface 321 and an insurance company interface 319.

The health care network 301 that is used by doctors, patients, nurses, DME offices, hospitals, etc. employs digital signatures and/or electronic image signatures for providing authentication, approval support, as well as security while accessing documents and other information. Electronic image signatures are attached to provide information about the approval, by physicians, of DME related documents and certificates of necessity.

Electronic image signatures are used along with digital signatures to authenticate the documents and other information. Doctor's and DME Offices are provided digital certificates that are used for secure communications and authentication. In addition, doctors, nurses, etc. provide a copy of their signatures, preferably in electronic form, to the DME provider computing system 310 (or faxed to it), to be stored as an electronic image signature and used during a document (and certificates of necessity) signing process. A copy of their electronic image signatures are stored in the web-based DME management system 360.

When a user, such as a doctor, signs a document, such as a patient's documents, an electronic image signature of the user is selectively employed, along with the user's digital signatures that are based on public and private keys, to authenticate the user and determine the identity of the signer. Such a mechanism makes it possible to employ the electronic image signature as proof of the user having signed the document. In addition, when the document is printed or viewed on the screen, the inclusion of the electronic image signature on the display or the insertion of the watermarked electronic image signature in the printed output helps confirm the fact that the document has been previously signed, while also providing information about the signer's identity

Although a system and method according to the present invention has been described in connection with the preferred embodiment, it is not intended to be limited to the specific form set forth herein, but on the contrary, it is intended to cover such alternatives, modifications, and equivalents, as can be reasonably included within the spirit and scope of the invention as defined by this disclosure and appended diagrams

1. A healthcare network supporting the prescription of durable medical equipment (DME), the healthcare network comprising:
DME information regarding a patient and a certificate of medical necessity;
at least one database;
a first web server communicatively coupled to the at least one database;
a physician computer, communicatively coupled to the web server, running browser software used by a physician to review the DME information and the certificate of medical necessity;
at least one web page, selectively delivered by the web server to the physician computer, that presents the certificate of medical necessity and the DME information for review by the physician; and
the physician computer responding to input from the physician by at least initiating approval of the certificate of medical necessity and communicating an approved certificate of medical necessity to the web server, the web server storing the approved certificate of medical necessity in the at least one database for future access.

2. The healthcare network of claim 1 further comprising a second web server communicatively coupled to the first web server, the second web server enabling review by a DME provider of the DME information and the approved certificate of medical necessity.

3. The healthcare network of claim 1 further comprising DME advisor software for assisting a care provider in the creation of a DME care plan.

4. The healthcare network of claim 3 wherein the DME advisor software is associated with at least one of the physician computer and the first web server.

5. The healthcare network of claim 1 further comprising a second web server, and wherein the first web server communicates the DME information and the approved certificate of medical necessity to the second web server, and wherein the second web server generates billing information using the DME information and the approved certificate of medical necessity:

6. The healthcare network of claim 1 further comprising a second web server, and wherein the second web server communicates the DME information and the certificate of medical necessity to the first web server.

7. The healthcare network of claim 6 wherein the DME information is generated by a care provider, and input via facsimile for communication by the second web server.

8. The healthcare network of claim 6 wherein the first web server stores the DME information and the certificate of medical necessity in the at least one database.

9. The healthcare network of claim 1 wherein the first web server retrieves at least one of the DME information and the certificate of medical necessity from the at least one database.

10. A method of supporting the prescription durable medical equipment (DME) in a healthcare network, the method comprising:
receiving DME information regarding a patient and a certificate of medical necessity;
presenting the DME information and the certificate of medical necessity to a physician computer;
receiving an approved certificate of medical necessity from the physician computer; and
storing the approved certificate of medical necessity in at least one database for future access.

11. The method of claim 10 further comprising:
retrieving the approved certificate of medical necessity from the at least one database; and
communicating the approved certificate of medical necessity to a DME provider.

12. The method of claim 10 further comprising presenting DME advice to the physician computer.

13. The method of claim 10 further comprising:
retrieving the approved certificate of medical necessity from the at least one database; and
communicating the approved certificate of medical necessity to a billing system for generation of billing information based thereon.

14. The method of claim 10 wherein the DME information and the certificate of medical necessity are received from a DME provider.

15. The method of claim 10 further comprising storing the DME information and the certificate of medical necessity in the at least one database.

16. The method of claim 10 wherein the DME information and the certificate of medical necessity are retrieved from the at least one database.

17. A healthcare network supporting the prescription of durable medical equipment (DME), the healthcare network comprising:
at least one database that stores DME information regarding a patient and a certificate of medical necessity;
a first web server communicatively coupled to the at least one database;
a physician computer, communicatively coupled to the web server, running browser software used by a physician to review the DME information and the certificate of medical necessity;
at least one web page, selectively delivered by the web server to the physician computer, that presents the certificate of medical necessity and the DME information for review by the physician; and
the physician computer responding to input from the physician by at least initiating approval of the certificate of medical necessity and communicating an approved certificate of medical necessity to the web server, the web server storing the approved certificate of medical necessity in the at least one database for future access.

18. The healthcare network of claim 17 further comprising a second web server communicatively coupled to the first web server, the second web server delivering the DME information and the certificate of medical necessity to the first web server for storage in the at least one database.

19. The healthcare network of claim 17 further comprising a second web server, and wherein the first web server communicates the DME information and the approved certificate of medical necessity to the second web server, and wherein the second web server generates billing information using the DME information and the approved certificate of medical necessity.

20. The healthcare network of claim 19 wherein the second web server is associated with HCFA.
